(19) United States
(12) Patent Application Publication
(10) Pub. No.: US 2005/0094337 A1
(43) Pub. Date: May 5, 2005

(54) Device driving method, and a device driving apparatus, a signal switching apparatus

(75) Inventor: Hisao Kakitani, Tokyo (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: AGILENT TECHNOLOGIES, INC.

(21) Appl. No.: 10/930,250

(22) Filed: Aug. 31, 2004

(30) Foreign Application Priority Data
Oct. 31, 2003 (JP) 2003-371749

(51) Int. Cl. H02H 7/00

(52) U.S. Cl. 361/64

(57) ABSTRACT

A signal switching apparatus comprising multiple relays, multiple photocouplers, wherein an output from the photocouplers is connected to the coils of the multiple relays, and a control device that controls the photocouplers. The coils of the above-mentioned multiple relays are connected so that they are distributed between a positive electrical source and a negative electrical source so that the current flowing to the ground is small.

### 1. FIELD OF THE INVENTION

The present invention relates to a signal switching apparatus and in particular, to a signal switching apparatus comprising multiple relays. Moreover, the present invention relates to an apparatus that drives multiple electrical devices. The present invention is ideal for a signal switching device having multiple relays, and the like.

### 2. DISCUSSION OF THE BACKGROUND ART

Conventional semiconductor testers comprise many relays for switching signals. Mercury relays and mechanical relays such as reed relays are used in relays so that the signals will not degrade. Mechanical relays comprise coils and are relays with which the electrical circuit is switched by the electromagnetic effect of these coils.

A conventional signal switching apparatus that uses relays is shown in FIG. 1. A signal switching apparatus 100 in FIG. 1 comprises a control device 110; a transistor array 120; and a relay 130. Control device 110 is a device that outputs control signals to transistor array 120, and is connected to electrical source VD and ground GND. Transistor array 120 is a transistor array comprising a Darlington pair. The base of transistor array 120 is connected to control device 110 via a resistor, the collector is connected to relay 130, and the emitter is connected to ground GND. Relay 130 comprises a switch 131 that switches signals, and a coil 132 that turns switch 131 on and off. Coil 132 is connected to the electrical source VDR and the collector of transistor array 120. Control device 110 is a microprocessor, FGPA, or the like employed in semiconductor tests. Thus, it is it is difficult to drive coil 132 directly using control device 110, and as previously mentioned, transistor array 120 is placed in between control device 110 and relay 130 (for instance, JP (Jitsuyo) 63[1988]-7932 (FIG. 1) or JP (Kokai) 60[1985]-183,991 (FIG. 3)).

The current output from control device 110 and the current that flows through coil 132 flow into the emitter of transistor array 120 and therefore, the ground to which control device 110 is connected and the ground to which transistor array 120 is connected must be a common ground. Consequently, the electrical source connected to coil 132 must be a positive electrical source.

Moreover, the electrical source connected to coil 132 must have a voltage that is at least the value that is obtained by adding the collector-emitter voltage during saturated operation of transistor array 120 to the operating voltage of relay 130. The collector-emitter voltage during saturated operation of a Darlington-pair transistor array is generally 1 V. Consequently, when the operating voltage of relay 130 is 5 V, the voltage of the electrical source connected to coil 132 must be 6 V or higher. A 6V electrical source is not commonly used for electronic devices in general.

Semiconductor testers comprise many signal switching apparatuses. A relay drive current of 30 milliamperes to 40 milliamperes is generally necessary. Consequently, in addition to the electrical source that supplies current to the electronic devices, semiconductor testers comprise large-capacity positive electric sources for relays. Moreover, a large current flows to the ground when the relay is being driven and therefore, the semiconductor tester has a ground pattern that becomes denser around the relay and it further comprises many parts intended to counter noise, such as large common mode choke coils.

The present invention provides a signal switching apparatus that does not require a special electrical source, dense ground pattern, or many parts intended to counter noise.

### SUMMARY OF THE INVENTION

The present invention is a driving method for driving multiple electrical devices, comprising a step whereby current is supplied to each of these electrical devices from either a positive electrical source or a negative electrical source connected to a common reference potential, with the positive electrical source and the negative electrical source being divided to the devices and current being supplied to each of these electrical devices such that the difference between the total current supplied from this positive electrical source to these electrical devices and the total current supplied from this negative electrical source to these electrical devices is reduced; and a step whereby the current that flows to these electrical devices is allowed to continue or be interrupted in response to signals from an apparatus that is electrically isolated from this positive electrical source and this negative electrical source.

The present invention also provides for an electrical device driving apparatus, characterized in that it is an apparatus for driving multiple electrical devices; it comprises multiple switch means; these switch means comprise an input part and a switch part that are electrically isolated from one another and these switch parts work in response to signals input to this input part; and each switch part of these switch means is connected, with at least one of these electrical devices in between, to either a positive electrical source or a negative electrical source connected to a common reference potential and these switch parts are connected so that they are distributed between the positive electrical source and the negative electrical source such that the difference between the total current flowing to the switch parts connected to this positive electrical source and the total current flowing to the switch parts connected to this negative electrical source is reduced.

The switch parts connected to this positive electrical source and the switch parts connected to this negative electrical source are further virtually simultaneously brought to a state of conduction.

The present invention is also includes a signal switching apparatus that switches between multiple signals; it comprises multiple relays and multiple photocouplers; the output part of each of these photocouplers is connected to the coil of at least one of these relays; and each coil of these relays is connected to a positive electrical source or a negative electrical source having a common ground, with these coils being connected so that they are distributed between the positive electrical source and the negative electrical source such that the difference between the total current flowing to the coils connected to this positive electrical source and the total current flowing to the coils connected to this negative electrical source is reduced. The signal switching apparatus may further comprise a control device for controlling each of these photocouplers so that the coils connected to this positive electrical source and the coils connected to this negative electrical source are driven virtually simultaneously.

The photocouplers are transistor output photocouplers. Alternatively, the photocouplers are MOS-FET output photocouplers.

### BRIEF DESCRIPTION OF THE DRAWINGS

FIG. 1 is a drawing showing a conventional signal switching apparatus.

FIG. 2 is a drawing showing a signal switching apparatus that is the first embodiment of the present invention.

FIG. 3 is a drawing showing a signal switching apparatus that is the second embodiment of the present invention.

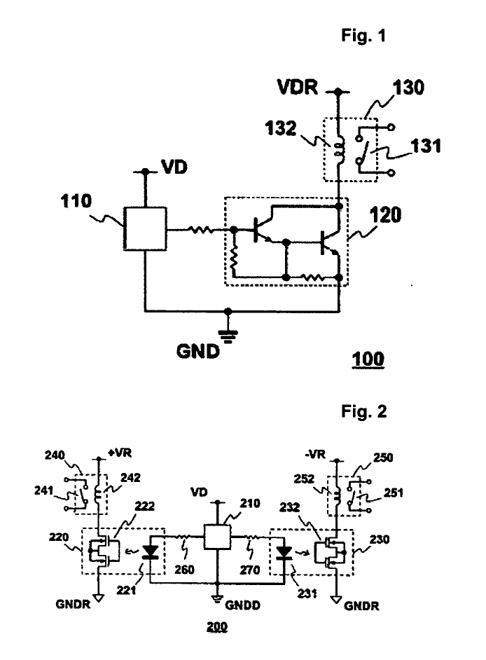

### DETAILED DESCRIPTION OF THE PREFERRED EMBODIMENT

According to the present invention, multiple relays of a signal switching apparatus comprising multiple relays are driven by photocouplers and therefore, the relay drive electrical source is not limited to a positive electrical source. Moreover, according to the present invention, these multiple relays of a signal switching apparatus comprising multiple relays are driven by a MOS-FET output photocoupler with low resistance and therefore, selection of the relay drive electrical source is simple. Consequently, the signal switching apparatus comprising multiple relays according to the present invention does not require a special relay electrical source.

Furthermore, according to the present invention, these multiple relays of a signal switching apparatus comprising multiple relays are connected so that they are distributed between a positive electrical source and a negative electrical source and therefore, the current that flows into the ground when the relay is driven is controlled and many parts intended to counter noise, such as a large common mode choke coil, and a dense ground pattern are not necessary.

Based on the above-mentioned effects, for instance, the part of the semiconductor tester that is associated with the signal switching apparatus can be reduced in size without compromising function or performance.

The present invention will be described in detail based on the embodiments shown in the attached drawings. The first embodiment is a signal switching apparatus comprising multiple relays, and a block diagram thereof is shown in FIG. 2. A signal switching apparatus 200 in FIG. 2 comprises a control device 210, a photocoupler 220, a photocoupler 230, a reed relay 240, and a reed relay 250. Control device 210 is a device that outputs signals for controlling photocoupler 220 and photocoupler 230 and is connected to a positive electrical source VD and ground GNDD. Photocoupler 220 and photocoupler 230 are MOS-FET output photocouplers. Photocoupler 220 comprises an input part 221 and an output part 222 that are electrically isolated from one another, and output part 222 performs a switching operation in response to signals input to input part 221. Input part 221 comprises a light-emitting device connected to control device 210 via a resistor 260. The resistance of resistor 260 is determined from the voltage of control signals output by control device 210 and the current for driving input part 221. Output part 222 comprises an optically-driven MOS-FET and operates as a switch. Moreover, output part 222 provides for conduction or interrupts the circuit between reed relay 240 and ground GNDR. Photocoupler 230 comprises an input part 231 and an output part 232 that are electrically isolated from one another and output part 232 performs a switching operation in response to signals input to input part 231. Input part 231 comprises a light-emitting device connected to control device 210 via a resistor 270. The resistance of resistor 270 is determined from the voltage of the control signals output by control device 210 and the current for driving input part 231. Output part 232 comprises an optically-driven MOS-FET and operates as a switch. Output part 232 allows current to flow or interrupts the circuit between reed relay 250 and ground GNDR. Reed relay 240 comprises a switch 241 that switches signals and a coil 242 that turns switch 241 on or off by an electromagnetic effect. Coil 242 is connected to a positive electrical source (+VR) and output part 222 of photocoupler 220. Reed relay 250 comprises a switch 251 that switches signals and a coil 252 that turns switch 251 on or off by an electromagnetic effect. Coil 252 is connected to a negative electrical source (−VR) and output part 232 of photocoupler 230. Moreover, when output part 222 of photocoupler 220 and output part 232 of photocoupler 230 are in a state of conduction, the current flowing to coil 242 and the current flowing to coil 252 are virtually the same.

By means of signal switching apparatus 200 with this type of structure, control device 210 outputs control signals such that output part 222 of photocoupler 220 and output part 232 of photocoupler 230 conduct a current virtually simultaneously, preferably perfectly simultaneously. Thus, reed relay 240 and reed relay 250 operate virtually simultaneously, preferably perfectly simultaneously, and the current that flows from positive electric source (+VR) through coil 242 to ground GNDR flows through coil 252 to negative electrical source (−VR) in unaltered form. As a result, signal switching apparatus 200 does not require many parts intended to counter noise such as a large common mode choke coil, or a dense ground pattern. Moreover, photocoupler 220 and photocoupler 230 are MOS-FET output photocouplers and therefore, the voltage drop caused by output part 222 and output part 232 is sufficiently small in comparison to the sensitivity voltage of reed relay 240 and reed relay 250. Consequently, the absolute output voltage of positive electrical source (+VR) and negative electrical source (−VR) can be the same as this sensitivity voltage. That is, selection of the electrical source that drives reed relay 240, and the like is simplified.

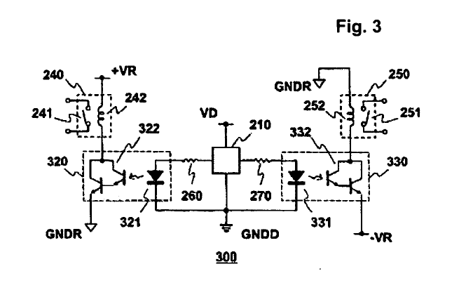

The MOS-FET output photocoupler of signal switching apparatus 200 can also be replaced by a transistor output photocoupler. A signal switching apparatus of this type is shown in FIG. 3 as the second embodiment of the present invention. A signal switching apparatus 300 in FIG. 3 comprises a control device 210, a photocoupler 320, a photocoupler 330, a reed relay 240, and a reed relay 250. Control device 210 is a device that outputs signals for controlling photocoupler 320 and photocoupler 330, and is connected to a positive electrical source VD and ground GNDD. Photocoupler 320 and photocoupler 330 are transistor output photocouplers. Photocoupler 320 comprises an input part 321 and an output part 322 that are electrically isolated from one another, and output part 322 performs a switching operation in response to signals input to input part 321. Input part 321 comprises a light-emitting device connected to control device 210 via a resistor 260. The resistance of resistor 260 is determined from the voltage of control signals output by control device 210 and the current for driving input part 321. Output part 322 comprises an optically-driven Darlington pair and operates as a switch. Moreover, output part 322 provides for conduction or interrupts the circuit between reed relay 240 and ground GNDR. Photocoupler 330 comprises input part 331 and output part 332 that are electrically isolated from one another, and output part 332 performs a switching operation in response to signals input to input part 331. Input part 331 comprises a light-emitting device connected to control device 210 via a resistor 270. The resistance of resistor 270 is determined from the voltage of the control signals output by control device 210 and the current for driving input part 321. Output part 332 comprises an optically-driven Darlington pair and operates as a switch. Output part 332 allows for conduction or interrupts the circuit between reed relay 250 and a negative electrical source (−VR). Reed relay 240 comprises a switch 241 that switches signals and a coil 242 that turns switch 241 on or off by an electromagnetic effect. Coil 242 is connected to a positive electrical source (+VR) and output part 322 of photocoupler 320. Reed relay 250 comprises a switch 251 that switches signals and a coil 252 that turns switch 251 on or off by an electromagnetic effect. Coil 252 is connected to ground GNDR and output part 332 of photocoupler 330. Moreover, when output part 322 of photocoupler 320 and output part 332 of photocoupler 330 are in a state of conduction, the current flowing to coil 242 and the current flowing to coil 252 are virtually the same.

By means of signal switching apparatus 300 with this type of structure, control device 210 outputs control signals such that output part 322 of photocoupler 320 and output part 332 of photocoupler 330 conduct a current virtually simultaneously, preferably perfectly simultaneously. Thus, reed relay 240 and reed relay 250 operate virtually simultaneously, preferably perfectly simultaneously, and the current that flows from positive electrical source (+VR) through coil 242 to ground GNDR flows through coil 252 to negative electrical source (−VR) in unaltered form. As a result, signal switching apparatus 300 does not require many parts intended to counter noise such as a large common mode choke coil, or a dense ground pattern.

One requirement of the present invention is that the relay coils are connected to either a positive electrical source or a negative electrical source, with the coils being connected so that they are distributed between a positive electrical source and a negative electrical source such that the difference between the current that flows to the coils connected to the positive electrical source and the current flowing to the coils connected to the negative electrical source is reduced. For instance, 20 of 40 relays having the same properties are connected directly or indirectly to the positive electrical source and the other 20 are connected directly or indirectly to the negative power source. Moreover, if there are 39 relays having the same properties, 20 of these are directly or indirectly connected to the positive electrical source and the remaining 19 are directly or indirectly connected to the negative power source. Furthermore, when there is a mixture of relays having different properties, for instance, when there are coils with a rated current of 30 mA and coils with a rated current of 20 mA, 20 relays comprising coils with a rated current of 30 mA are connected to the positive electrical source and 30 relays comprising coils having a rated current of 20 mA are connected to the negative electrical source. These multiple relays can be divided into at least two groups and controlled together in each group, or they can all be controlled individually.

Consequently, the number of relays or photocouplers connected to the positive electrical source or the negative electrical source is not limited to only one as with the signal switching device shown in FIG. 2 or FIG. 3. Moreover, the number of relays or photocouplers connected to the positive electrical source and the negative electrical source is not necessarily the same. Furthermore, multiple relays can be controlled by one photocoupler. In addition, the voltage of the positive electrical source and the negative electrical source can be the same or different. The positive electrical source and the negative electrical source are not necessarily single-circuit sources. For instance, the positive electrical source can be a dual-circuit source and the negative electrical source can be a single-circuit source. However, in this case the current flowing into the ground and the current flowing out from the ground when the relay is being driven must be the same whenever possible. In other words, the coils are connected so that they are distributed between the positive electrical source and the negative electrical source so that the difference between the total current that flows into the coil connected to two positive electrical sources and the total current that flows into the coil connected to the negative electrical source is small.

Ground in the present text means the reference potential and is not restricted to ground potential. Moreover, ground GNDR and ground GNDD have independent potentials and these potentials can be the same or different.

The present invention is not limited to the driving of relays and is applicable to the driving of other types of electrical devices. For instance, the present invention is applicable to separately driving multiple high-luminance LEDs in large video display devices.

1. A method for driving multiple electrical devices which comprises:
supplying current to each of said electrical devices from either a positive electrical source or a negative electrical source connected to a common reference potential, with the positive electrical source and the negative electrical source being divided to said electrical devices and current being supplied to each of said electrical devices such that the difference between the total current supplied from said positive electrical source to said electrical devices and the total current supplied from said negative electrical source to said electrical devices is reduced; and
allowing said current that flows to said electrical devices to be conducted or be interrupted in response to signals from an apparatus that is electrically isolated from said positive electrical source and said negative electrical source.

2. An electrical device driving apparatus for driving multiple electrical devices, said electric device driving apparatus comprising:
multiple switches which comprise an input part and a switch part that are electrically isolated from one another and said switch part performs a switching operation in response to signals input to said input part; and
each switch part of said switch is connected, with at least one of said electrical devices in between, to either a positive electrical source or a negative electrical source connected so that they are to a common reference potential and said switch part is connected so as to distribute between the positive electrical source and the negative electrical source such that the difference between the total current flowing to said switch part connected to said positive electrical source and the total current flowing to said switch part connected to said negative electrical source is reduced.

3. The electrical device driving apparatus according to claim 2, wherein said switch part connected to said positive electrical source and said switch part connected to said negative power source are virtually simultaneously brought to a state of conduction.

4. A signal switching apparatus that switches between multiple signals, said apparatus comprising:
multiple relays; and
multiple photocouplers;
wherein the output part of each of said photocoupler is connected to the coil of at least one of said relays, and wherein each coil of said relay is connected to a positive electrical source or a negative electrical source having a common ground, with said coils being connected so that they are distributed between the positive electrical source and the negative electrical source such that the difference between the total current flowing to said coils connected to said positive electrical source and the total current flowing to said coils connected to said negative electrical source is reduced.

5. The signal switching apparatus according to claim 4, further comprising a control device for controlling each of said photocouplers such that said coils connected to said positive electrical source and said coils connected to said negative electrical source are driven virtually simultaneously.

6. The signal switching apparatus according to claim 4, wherein said photocouplers are transistor output photocouplers.

7. The signal switching apparatus according to claim 4, wherein said photocouplers are MOS-FET output photocouplers.
